(19) United States
(12) Patent Application Publication
(10) Pub. No.: US 2002/0153789 A1
(43) Pub. Date: Oct. 24, 2002

(54) Pressurized bearing system for submersible motor

(76) Inventors: Dick L. Knox, Claremore, OK (US); George Soukup, Broken Arrow, OK (US)

Correspondence Address: James E. Bradley, BRACEWELL & PATTERSON, L.L.P., Suite 2900, 711 Louisiana, Houston, TX, 77002, US

(21) Appl. No.: 09/838,741

(22) Filed: Apr. 19, 2001

(51) Int. Cl. H02K 5/10

(52) U.S. Cl. 310/90

(57) ABSTRACT

A method and device are provided for stabilizing shaft bearings in a motor having a hollow shaft and holes communicating the shaft and the bearings. A lubricant pump is provided for pressurizing a volume of lubricant located within the motor housing, the pump having a set of impellers attached to a lower end of the shaft and rotating with the shaft, the impellers being located in the flow path of the lubricant. A diffuser is located upstream of and adjacent each impeller. The impellers increase the radial velocity of the lubricant, and this velocity is converted into a pressure head at the impeller outlet. The lubricant flows through the first diffuser, through the first impeller, through the second diffuser, and then flows through the second impeller and out into a reservoir. The pressure causes the lubricant to flow through the hollow shaft and through passages to stabilize the bearings.

### BACKGROUND OF THE INVENTION

1. Field of the Invention

This invention relates generally to electric, submersible pump assemblies and relates particularly to a pump assembly having an internal lubricant pump which pressurizes the lubricant to stabilize bearings for the motor shaft.

2. Description of the Prior Art

A conventional, electric, submersible pump (ESP) assembly includes an electric motor and a pump that is used to pump oil or other fluids within a wellbore. The electric motors have a rotatable rotor that is contained within a stationary stator. The rotors for the submersible pumps are usually disposed in substantially vertical position by virtue of their placement in wellbores, which typically are vertical shafts. Therefore, during operation, the rotor shaft of the motor is oriented in the vertical position.

The bearings which surround the rotor shaft are often of the fluid film variety. However, fluid film bearings require a side load to provide optimal dynamic stability. Since the rotor shaft is rotating in a vertical position, there is little or no side load being applied to the bearing during operation. This causes instability in the bearings, which results in excessive motor vibration. Excessive vibration in the bearings can cause the bearing sleeves to break through the lubricant film, resulting in metal-to-metal contact that can lead to premature wear and motor failure.

A typical motor contains an internal lubrication system that circulates lubricant from a reservoir, through a hollow motor shaft, and through passages in the shaft to lubricate bearings surrounding the shaft. The lubricant may also circulate through a heat exchanger and through a particle filter and/or a hygroscopic material to remove heat and contaminants from the lubricant. The circulation of the lubricant is normally by convection, although prior art patents show one or more impellers located in the flow path, the impellers being attached to and rotating with the hollow shaft. The circulation does not pressurize the lubricant sufficiently for stabilization of the bearings.

Where lateral loading of a component is too low for fluid film stabilization of journal bearings, pressurization of the lubricant may be used. Stabilization occurs when a lubricant is fed into a bearing-component interface at a pressure sufficient to maintain a film between the component and the bearing even when there is minimal loading. While some pressure is developed in an ESP motor designed for lubricant circulation, it is much too low to achieve stabilization of the bearing through fluid film stabilization.

### SUMMARY OF THE INVENTION

A method and device are provided for stabilizing shaft bearings in a submersible oil-and-gas-well pump assembly by increasing the lubricant pressure to achieve fluid-film stabilization. The assembly includes a motor having a hollow shaft and holes communicating the shaft and the bearings, the assembly also containing a volume of lubricant. A lubricant pump is provided for pressurizing the lubricant. The lubricant pump has a set of impellers attached to a lower end of the shaft within the motor and rotating with the shaft, the impellers being located in the flow path of the lubricant. A diffuser is located upstream of and adjacent each impeller for slowing the incoming lubricant. The impellers increase the radial velocity of the lubricant, and this velocity is converted into a pressure head at the exit of the impeller.

The lubricant flows through the first diffuser and into the inlet of the first impeller. The lubricant then flows through the second diffuser and second impeller and flows out of the outlet of the second impeller into a reservoir. The first stage pressurizes the lubricant to a pressure level, and the second stage pressurizes the lubricant to a second, higher pressure level. The pressure in the reservoir causes the lubricant to flow through the hollow shaft and through passages to the bearings. The lubricant is pressurized to a pressure sufficient to induce a film of lubricant between the shaft and the bearings, the film preventing the shaft from contacting the bearings, thus stabilizing the bearings.

### BRIEF DESCRIPTION OF THE DRAWINGS

The novel features believed to be characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a sectional view schematically illustrating a submersible pump assembly constructed in accordance with this invention and installed in a well.

FIG. 2 is a sectional view illustrating a lower section of the motor of a submersible pump assembly constructed in accordance with this invention.

### DETAILED DESCRIPTION OF THE INVENTION

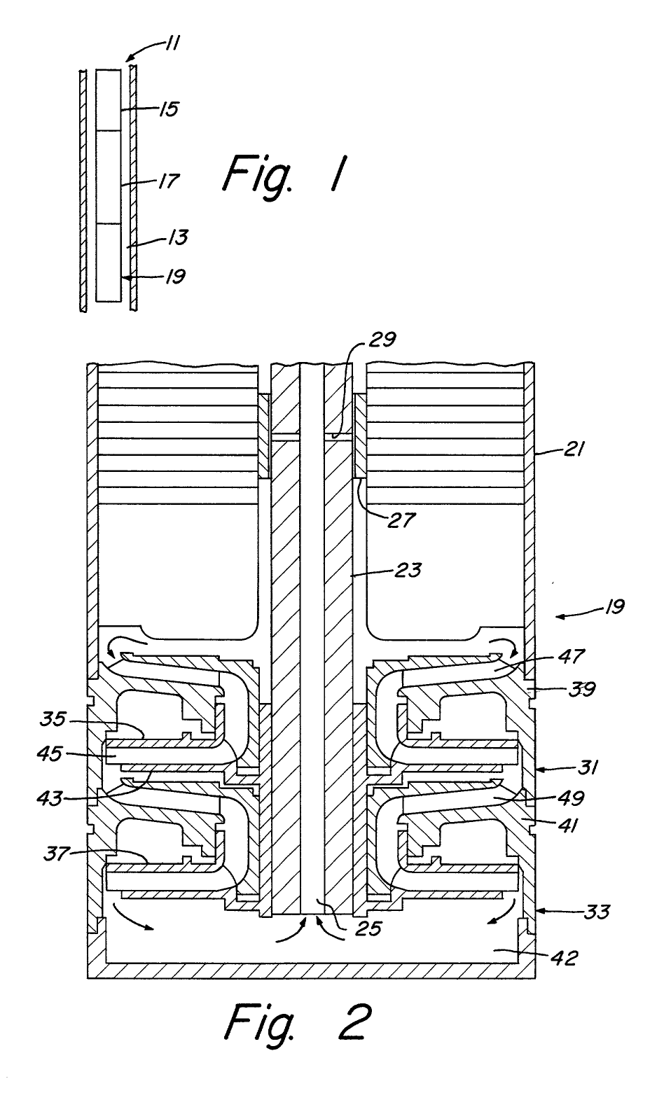

Referring to FIG. 1, a downhole, electric, submersible pump (ESP) assembly 11 is shown installed in a well 13. ESP assembly 11 comprises a pump 15, a seal section 17, and a motor 19. Pump 15 is used to pump well fluids from within the well to the surface. Pump 15 may be a centrifugal pump having a plurality of stages, each stage having an impeller and a diffuser for imparting an upward force to the fluid. Alternatively, pump 15 may be a progressive-cavity pump having an elastomeric stator and a metal rotor that rotates within the stator. Motor 19 is connected to a source of electricity by a cable or other means (not shown) for powering motor 19. The shaft of motor 19 is coupled to shafts within seal section 17 and pump 15 to transfer torque from motor 19 to pump 15. Motor 19 creates a torque on the shafts to cause the shafts to rotate, providing power to drive pump 15.

FIG. 2 is a sectional view of the lower portion of motor 19. Motor 19 has a housing 21 which surrounds components within motor 19 and protects components from contact with well fluids. Motor shaft 23 is cylindrical and extends from the upper portion of motor 19 to the lower portion of motor 19. A rotor (not shown) is mounted to shaft 23 for rotation within a stationary stator (not shown). Shaft 23 contains a coaxial lubricant passage 25 through at least a portion of shaft 23 for providing lubricant to a set of bearings 27. Bearings 27 center and laterally support motor shaft 23 within the stator and are located at various locations along the length of shaft 23. Holes 29 through the wall of shaft 23 and adjacent to bearings 27 permit lubricant in passage 25 to flow into the area between bearings 27 and shaft 23. There are preferably three holes 29 to balance the pressure around shaft 23. Bearings 27 are schematically illustrated to be cylindrical journal bearings, but bearings 27 could be other types such as, for example, tri-lobe bearings.

An internal, multi-stage, centrifugal lubricant pump has an upper stage 31 and a lower stage 33, each stage having an impeller 35, 37 and a diffuser 39, 41. Upper stage 31 increases the pressure of the lubricant to a first level, and lower stage 33 increases the pressure to a second level. The lubricant pump is located within a lower portion of housing 21 for pressurizing and circulating lubricant. Alternatively, the lubricant pump can be located within an upper portion of housing 21.

Each impeller 35, 37 comprises two circular plates 43 stacked vertically and having a plurality of vanes 45 attached to and between plates 43. Vanes 45 define separate passages between plates 43. Impellers 35, 37 are attached to and rotate with shaft 23 to draw lubricant into a central portion of impeller 35, 37 and increase the velocity of the lubricant at a discharge at a periphery. In this embodiment, impellers 35, 37 are oriented to discharge lubricant downward, however they could be oriented to discharge upward. Impellers 35, 37 are preferably straight-vane impellers which, while less efficient, would allow bidirectional operation of the pump. Impellers 35, 37 are shown to be a radial-flow type which directs the flow from the passages between the vanes radially outward. Mixed-flow impellers, which direct flow axially as well as radially, may also be employed in some cases. However, mixed-flow stages do not provide as much pressure increase as radial-flow types, instead providing more velocity. A lubricant reservoir 45 is located below impeller 37.

Diffusers 39, 41 are mounted to the inner surface of motor housing 21 and are stationary relative to impellers 35, 37. Diffuser 39 is located above impeller 35, and diffuser 41 is located between impellers 35, 37. Each diffuser 39, 41 has a plurality of passages 47, 49 that lead downward and inward from a periphery to a central outlet. Each central outlet registers with the inlet of one of impellers 35, 37. Diffusers 39, 41 serve to slow the lubricant before it enters each impeller 35, 37, increasing the pressure head of the lubricant at the exit of each impeller 35, 37.

In operation, housing 21 is vacuum-filled with a volume of lubricant, and ESP assembly 11 (FIG. 1) is assembled and inserted into well 13 (FIG. 1). Once the electrical connection to motor 19 is made, the system can be started. As motor shaft 23 starts to rotate, upper impeller 35 draws lubricant from above upper diffuser 39 and draws it through upper diffuser 39 creating a pressure head at the central outlet of diffuser 39. Upper impeller 35 increases the velocity of the lubricant as it directs the lubricant outward to the intake of lower diffuser 41. Lower diffuser 41 directs the flow radially inward and downward, increasing the pressure head. The lubricant has an increased pressure head before entering lower impeller 37. The lubricant passes out of the exit of lower impeller 37 and into reservoir 45 with a higher pressure than at the exit of the first impeller.

The increase in pressure in reservoir 45 forces the lubricant to travel up passage 25 where it enters holes 29. The pressure causes the lubricant to flow between bearings 27 and shaft 23 and to form a film in the interface, thus stabilizing bearings 27. The pressure must be maintained above a critical level to ensure the continued stability of bearings 27. Typically, the necessary pressure ranges between 30 and 100 pounds per square inch.

The advantage of a pressurized bearing system is that metal-to-metal contact of shaft 23 and bearings 27 is limited or eliminated. This reduces the frequency of required replacement of bearings 27 and provides for a longer run-time between failures. The present invention provides for a simple, reliable, and inexpensive method of pressurization and stabilization.

While the invention is shown in only one of its forms, it should be apparent to those skilled in the art that it is not so limited, but is susceptible to various changes without departing from the scope of the invention.

1. In an electric motor having a shaft, a bearing located within a housing adapted to be filled with lubricant, and passages communicating the shaft and the bearing, the improvement comprising:
at least one centrifugal lubricant pump stage located in the housing, the pump stage having an impeller attached to and rotating with the shaft and a mating diffuser for pressurizing the lubricant; and
a flow passage leading from the lubricant pump stage to the bearing.

2. The apparatus of claim 1, wherein:
the at least one pump stage further comprises a second pump stage having an impeller and a diffuser mounted in the housing downstream of the first pump stage for further pressurizing the lubricant.

3. The apparatus of claim 1, wherein:
the diffuser is upstream of the impeller.

4. The apparatus of claim 1, wherein:
the pump stage is oriented for discharging lubricant in an opposite direction from the bearings.

5. The apparatus of claim 1, wherein:
the impeller of the pump stage has substantially radial flow passages.

6. The apparatus of claim 1, wherein:
a chamber is located in a lower portion of the housing for containing a volume of lubricant;
the shaft is hollow and has a passage within for communicating fluid from the chamber to the bearings; and
the pump stage discharges downward.

7. An electric submersible pump assembly for a well, the assembly comprising:
an electrical motor having a shaft, a bearing located within a housing adapted to be filled with lubricant, and passages communicating the shaft and the bearing;
a chamber located in a lower portion of the housing for containing a volume of lubricant;
a flow passage within the shaft leading from the chamber to the bearing;
first and second centrifugal lubricant pump stages, each pump stage located in the housing and each having an impeller attached to and rotating with the shaft and a mating diffuser for pressurizing the lubricant; wherein
the diffuser in the first pump stage leads to the impeller in the first stage, the impeller of the first stage leads to the diffuser of the second stage, the diffuser of the second stage leads to the impeller of the second stage, and the impeller of the second stage leads to the chamber; and
a pump exterior of the motor and connected to the shaft for pumping well fluid.

8. The assembly of claim 7, wherein:
the impellers of the pump stages have substantially radial flow passages.

9. The assembly of claim 7, wherein:
the pump stages discharge downward and are located in a lower portion of the housing.

10. A method of stabilizing a bearing in a motor having a hollow shaft and passages communicating the shaft and the bearings, the motor having a housing containing a volume of lubricating fluid, the method comprising:
mounting at least one lubricant pump stage to the shaft within the housing, the pump stage having an impeller and a diffuser;
rotating the shaf and the impeller, pressurizing the lubricating fluid with the pump stage to a pressure sufficient to induce a film of lubricating fluid between the shaft and the bearings, the film preventing the shaft from contacting the bearings, thus stabilizing the bearings.

11. The method of claim 10, wherein:
the pressure in the hollow shaft is at least 30 pounds per square inch.
